(19) United States
(12) Patent Application Publication
(10) Pub. No.: US 2025/0190328 A1
(43) Pub. Date: Jun. 12, 2025

(54) SERVER CONFIGURATION DEBUGGING METHOD, SYSTEM AND DEVICE, MEDIUM AND COMPUTER PROGRAM PRODUCT

(71) Applicant: Shanghai Lilith Technology Corporation, Shanghai (CN)

(72) Inventors: Xing Zhang, Shanghai (CN); Shuo Lin, Shanghai (CN)

(21) Appl. No.: 18/842,312

(22) PCT Filed: Feb. 28, 2022
(86) PCT No.: PCT/CN2022/078218

§ 371 Date: Aug. 28, 2024

(51) Int. Cl. G06F 11/362

(52) U.S. Cl. CPC G06F 11/362

(57) ABSTRACT

The present invention relates to the technical field of servers, and in particular relates to a server configuration debugging method, system and device, a medium and a computer program product. The server configuration debugging method comprises: a receiving step of receiving a debugging configuration releasing message, wherein the debugging configuration releasing message comprises a debugging configuration entry, and the debugging configuration entry comprises a key, a value and a effectiveness rule; a query step of querying whether there is a predetermined key in the debugging configuration entry; a determination step of judging, when the predetermined key is found, whether the effectiveness rule is satisfied; and a reading step of reading the value when the effectiveness rule is satisfied. Configuration debugging verification may be carried out in a very small range. When there is a problem in the configuration, the risks may be greatly reduced, thereby preventing a wider impact range.

### TECHNICAL FIELD

The present invention relates to the technical field of servers, and in particular relates to a server configuration debugging method, system and device, a medium and a computer program product.

### BACKGROUND

In the field of server technology, container technology represented by Docker has the advantages of efficient deployment and automatic scaling. With the popularity of containerization, more and more game servers are being deployed in containers, making the deployment of game servers more and more convenient and quick. In general, when deploying a game server, the game server consists of two parts: the game server program and the game server configuration files. If a new game version is to be released, the game server program is generally updated: if the server parameters are to be adjusted, the server configuration files need to be modified. In actual operation, it is often necessary to modify the configuration of all game server nodes, and also to modify the configuration of a single game server node. In the traditional non-containerized deployment method, the conventional solution to achieve this requirement is:
1) modify the final game server configuration file locally;
2) release the new version of the game server configuration file to each server;
3) reload by calling the game server's reload configuration file API.

However, when using containerized deployment, the game server program and the game server configuration file are packed into the container image, and then the server downloads the container image to run, which will result in the need to repackage the image when modifying the server configuration parameters, restart the game server, and the overall complexity of the configuration updating process will become higher, and there is a service downtime impact on the players.

Especially in a distributed architecture, there are more and more business service nodes, and each business service node will load the corresponding configuration file when it starts. In the case of hot update of service configuration, once the configuration file is changed, the business service node will immediately use the new configuration parameters to process the business. Since the configuration parameters will take effect immediately after the change, once there is a problem with the configuration parameter content, all business service nodes will be affected, which may cause production-level accidents and even lead to significant economic losses.

### SUMMARY

The purpose of the present invention is to provide a server configuration debugging method, system and device, a medium and a computer program product, which can debug and verify configuration parameters in a very small range, and when there is a problem with the configuration parameters, the risk can be greatly reduced to avoid causing a wider range of impact.

An embodiment of the present invention discloses a server configuration debugging method, the method includes:
a receiving step, receiving a debugging configuration releasing message, wherein the debugging configuration releasing message includes a debugging configuration entry, and the debugging configuration entry includes a key, a value, and effectiveness rules:
a querying step, querying whether the debugging configuration entry contains a predetermined key:
a judging step, in the case where the predetermined key is found, judging whether the effectiveness rule is satisfied:
a reading step, in the case where the effectiveness rule is satisfied, reading the value.

Optionally, the effectiveness rules include probability effectiveness rules, timeliness effectiveness rules and specific effectiveness rules: wherein,
the probability effectiveness rule allows the debugging configuration entry to be read with a predetermined probability:
the timeliness effectiveness rule allows the debugging configuration entry to be read within a predetermined time:
the specific effectiveness rule allows the debugging configuration entry to be read in response to a read request carrying a predetermined ID.

Optionally, further including:
receiving a debugging configuration deletion message, wherein the debugging configuration deletion message includes a debugging configuration deletion field:
deleting the debugging configuration entry whose key is the debugging configuration deletion field.

Optionally, further including:
when the predetermined key cannot be found or the effectiveness rule is not satisfied, reading the value of the original configuration entry with the key.

Optionally, the receiving step further includes:
storing the debugging configuration entry.

An embodiment of the present invention discloses a server configuration debugging system including a configuration debugging platform and one or more business service nodes, wherein the business service nodes include a business module and a configuration debugging module, wherein:
the configuration debugging platform receives a debugging configuration releasing message, wherein the debugging configuration releasing message includes a debugging configuration entry, and the debugging configuration entry includes a key, a value, and effectiveness rules; and the configuration debugging platform sends the debugging configuration releasing message to the configuration debugging module of the business service node specified by the debugging configuration releasing message:
the configuration debugging module stores the received debugging configuration entry, and
according to the instruction of the business module, queries whether the debugging configuration entry contains a predetermined key,
in the case where the predetermined key is found, judges whether the effectiveness rule is satisfied,
in the case where the effectiveness rule is satisfied, reads the value of the debugging configuration entry and returns it to the business module.

Optionally, the effectiveness rules include probability effectiveness rules, timeliness effectiveness rules and specific effectiveness rules; wherein,
the probability effectiveness rule allows the debugging configuration entry to be read with a predetermined probability:
the timeliness effectiveness rule allows the debugging configuration entry to be read within a predetermined time:
the specific effectiveness rule allows the debugging configuration entry to be read in response to a read request carrying a predetermined ID.

Optionally, the configuration debugging platform also receives a debugging configuration deletion message, wherein the debugging configuration deletion message includes a debugging configuration deletion field; and the configuration debugging platform sends the debugging configuration deletion message to the configuration debugging module of the business service node specified by the debugging configuration deletion message:
after receiving the debugging configuration deletion message, the configuration debugging module deletes the debugging configuration entry whose key is the debugging configuration deletion field.

Optionally, the configuration debugging module reads the value of the original configuration entry with the key, when the predetermined key cannot be found or the effectiveness rule is not satisfied.

An embodiment of the present invention discloses a computer device, the device including a processor and a memory storing computer-executable instructions which, when executed by the processor, cause the device to implement the server configuration debugging method according to the embodiment of this invention.

An embodiment of this invention discloses a computer storage medium having stored thereon instructions which, when run on a computer, cause the computer to perform the server configuration debugging method according to the embodiment of this invention.

An embodiment of this invention discloses a computer program product including computer-executable instructions executed by a processor to implement the server configuration debugging method according to the embodiment of this invention.

Compared with the prior art, the embodiments of this invention have the following main differences and effects:

In the present invention, the server configuration debugging method comprises: a receiving step of receiving a debugging configuration releasing message, wherein the debugging configuration releasing message comprises a debugging configuration entry, and the debugging configuration entry comprises a key, a value and effectiveness rules: a query step of querying whether there is a predetermined key in the debugging configuration entry: a determination step of judging, when the predetermined key is found, whether the effectiveness rule is satisfied; and a reading step of reading the value when the effectiveness rule is satisfied. The debugging and verification of the configuration parameters may be carried out in a very small range. When there is a problem with the configuration parameters, the risks may be greatly reduced, thereby preventing a wider impact range. In practical applications, it can greatly improve the operational safety of operation and maintenance and reduce operation and maintenance accidents.

In the present invention, the effectiveness rules include probability effectiveness rules, timeliness effectiveness rules and specific effectiveness rules: wherein, the probability effectiveness rule allows the debugging configuration entry to be read with a predetermined probability: the timeliness effectiveness rule allows the debugging configuration entry to be read within a predetermined time: the specific effectiveness rule allows the debugging configuration entry to be read in response to a read request carrying a predetermined ID. On the basis of satisfying the configuration parameter verification, the impact range of debugging can be further reduced. The problem of the great risk generated once the configuration parameters are updated incorrectly is solved, and the risk is locked within a controllable range.

In the present invention, the method further includes: receiving a debugging configuration deletion message, wherein the debugging configuration deletion message includes a debugging configuration deletion field: deleting the debugging configuration entry whose key is the debugging configuration deletion field. Once a problem is found in the configuration content, the configuration parameters of these nodes can be quickly rolled back without reloading the configuration file or re-pulling it from the configuration center. Rapid emergency handling after the risk occurs further reduces the impact of configuration update problems.

### DESCRIPTION OF DRAWINGS

FIG. 1 is a block diagram of an exemplary server configuration debugging system according to an embodiment of the present application.

FIG. 2 is a flow chart of a server configuration debugging method according to an embodiment of the present application.

FIG. 3 is a hardware structure block diagram of a computer device for implementing server configuration debugging according to an embodiment of the present invention.

### DETAILED DESCRIPTION

The present application is further described below with reference to specific embodiments and the drawings. It should be understood that the specific embodiments described herein are used merely to explain the present application, but are not intended to limit the present application. In addition, for ease of description, only some but not all structures or processes related to the present application are shown in the drawings. It should be noted that in this description, similar numerals and letters designate like items in the following drawings.

It should be understood that although the terms first, second, etc. may be used in the present disclosure to describe various features, these features should not be limited to these terms. These terms are used for distinction only and shall not be understood as an indication or implication of relative importance. For example, without departing from the scope of example embodiments, a first feature may be referred to as a second feature, and similarly a second feature may be referred to as a first feature.

In the description of the present application, it is also to be noted that, unless expressly stated and defined otherwise, the terms “arrangement”, “connection”, “link” are to be understood in a broad sense, for example, as a fixed connection, as a detachable connection, or as an integrated connection: may be a mechanical connection or an electrical connection: may be directly connected or indirectly connected by means of an intermediate medium, and may be internal communication of the two elements. The specific meaning of the above terms in this embodiment will be understood by one of ordinary skill in the art.

Illustrative embodiments of the present application include, but are not limited to a server configuration debugging method, system and device, a medium and a computer program product.

Various aspects of the illustrative embodiments are described by using terms commonly used by persons skilled in the art to convey the substance of their work to others skilled in the art. However, it is apparent to the persons skilled in the art that some alternative embodiments may be practiced by using some of the described features. For purposes of explanation, specific numbers and configurations are set forth in order to provide a more thorough understanding of the illustrative embodiments. However, it is apparent to the persons skilled in the art that alternative embodiments may be practiced without the specific details. In other instances, well-known features have been omitted or simplified herein in order to avoid obscuring the illustrative embodiments of the application.

In addition, various operations will be described as a plurality of operations separated from each other in a manner most conducive to understanding the illustrative embodiments: however, the order of description should not be construed as to imply that these operations are necessarily dependent on the order of description, many of which operations may be performed in parallel, concurrently; or simultaneously. In addition, the order of operations can also be rearranged. When the described operations are completed, the processing may be terminated, but may further have additional steps not included in the figures. The processing may be corresponding to a method, a function, a procedure, a subroutine, a subprogram, or the like.

References in the specification to “an embodiment”, “embodiment”, “illustrative embodiment” and the like indicate that the described embodiments may include specific features, structures or properties, but each embodiment may or may not necessarily include specific features, structures or properties. Moreover, these phrases do not necessarily refer to the same embodiment. Furthermore, when certain features are described with reference to specific embodiments, the knowledge of the persons skilled in the art can affect the combination of these features with other embodiments, whether or not those embodiments are explicitly described.

Unless the context otherwise requires, the terms “comprising.” “having.” and “including” are synonyms. The phrase “A and/or B” indicates “(A), (B) or (A and B)”.

As used herein, the term “module” may refer to, be a part of, or include: a memory (shared, dedicated, or group), an application-specific integrated circuit (ASIC), an electronic circuit, and/or a processor (shared, dedicated, or a group) that can execute one or more software or firmware programs, a combinatorial logic circuit, and/or another proper component that provides the function.

In the drawings, some structural or methodological features may be shown in a particular arrangement and/or order. However, it should be understood that no such specific arrangement and/or ordering is required. Rather, in some embodiments, features may be described in a different manner and/or order than shown in the illustrative figures. In addition, the inclusion of structural or methodological features in a particular figure does not imply that all embodiments need to include such features, and in some embodiments, these features may not be included or may be combined with other features.

To make the objectives, technical solutions, and advantages of the present application clearer, the following further describes the embodiments of the present application in detail with reference to the accompanying drawings.

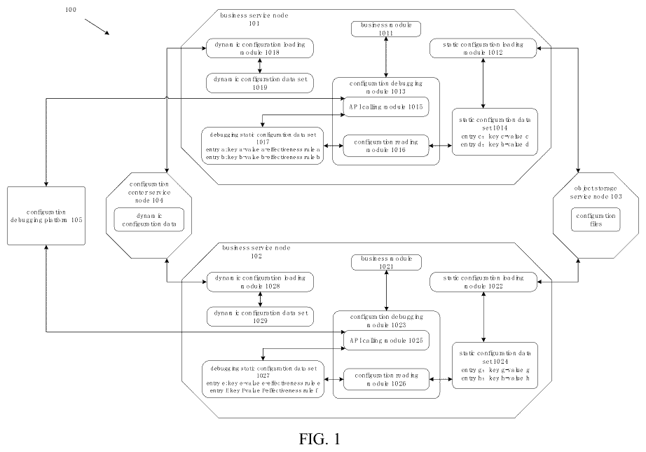

In order to solve the configuration update problem of the prior art during containerized deployment, an embodiment of the present application provides a server configuration debugging system. As shown in FIG. 1, an exemplary service configuration debugging system 100 according to an embodiment of the present application includes: business service nodes 101 and 102, object storage service node 103, configuration center service node 104 and configuration debugging platform 105.

Among them, business service nodes 101 and 102 can be game servers running in different containers to provide services to players. In a distributed system, the number of business service nodes can be deployed as needed. The container can be a container solution based on Docker, which is the basis for running a game server: when the game server is released, a container image will be packaged, which contains the game server program and configuration files: then run the container image in the container service of the production environment, and the game server can run.

The above container can be a Docker container. Data files will be generated during the use of the Docker container. These data files will disappear when the Docker container is closed. In order to make data persistent and completely independent of the life cycle of the container, Docker container data volumes can be used. Docker container data volumes are a way for containers to persist data during operation. Volumes are designated directories or files that can be shared between one or more containers. They are data mount points in the container (mounted to the container by the Docker). Data volumes do not belong to the Union File System (Union File System is the technical basis for implementing Docker images. It is a lightweight, high-performance layered file system that supports committing and layering modifications in the file system. This feature enables images to be implemented and inherited through layering. It also supports mounting different directories to the same virtual file system), so it can bypass the Union File System and provide some useful features for persistent or shared data. The data provided by the data volume can also be shared between the host and the container or between multiple containers.

Docker container data volumes also have the following features: 1) data volumes can share or reuse data between containers, 2) changes in data volumes can take effect directly without rebuilding the images, 3) changes in data volumes will not be included in updates to the images, 4) when the container is deleted, Docker will not delete the data volume mounted to the container, and the life cycle of the data volume continues until no container uses it.

The object storage service node 103 is a cloud service that is independent of the business service node that deploys the container and can be used to store various types of files. The object storage service node 103 can be used to save the static configuration files that the game server relies on. The object storage service node 103 can be configured as the mount point of the container (i.e., the above-mentioned Docker container data volume) through the container service. In this way, the game server (business service nodes 101 and 102) in the container can load the static configuration file in the object storage service node 103. When the business service nodes 101 and 102 are started, the static configuration file will be loaded by default.

The present invention adopts container mounting (Docker container data volume) technology to allow the container to access the configuration files in the external object storage service node, thereby realizing dynamic update.

The configuration center service node 104 is used to centrally manage server configurations and provide functions such as query: subscription, and push. When the game server is started, it first queries and subscribes to the required configuration parameters from the configuration center service node 104. When the configuration parameters of the configuration center service node 104 are modified, the changed content will be immediately pushed to the game server, thereby realizing dynamic and quick configuration modification of the game server.

The configuration debugging platform 105 provides a UI interface for the operation and maintenance administrator, on which the operation and maintenance administrator can easily create debugging configuration entries, select business service nodes to release, delete debugging configuration entries.

The business service node 101 includes a business module 1011, a static configuration loading module 1012 and a configuration debugging module 1013.

The business module 1011 is used to provide specific business services, such as a game server program.

The container of the business service node 101 will load the static configuration file in the object storage service node 103 into the file system of the container. The static configuration loading module 1012 is used to load the static configuration file from the file system into the memory (for example, when the game server is started). After the static configuration file is loaded into the memory; a static configuration data set 1014 is formed. The static configuration data set 1014 is provided to the game server logic code for use. When the game server logic code needs to query a certain configuration, it will query the static configuration data set 1014. The static configuration data set 1014 includes many configuration entries, each of which includes a Key and a Value. For example, the static configuration data set 1014 includes an entry c and an entry d. The entry c includes the value c of the key c, and the entry d includes the value d of the key b. The business module 1011 uses the Key to query the corresponding Value for business processing. The static configuration data 1014 includes various configurations for the operation of the business service node 101 (game server), such as database connection information, game external port information, player request current limiting configuration, etc. In addition, the static configuration loading module 1012 also provides a reloading API for the operation and maintenance administrator to call. When the operation and maintenance administrator calls the API, the static configuration loading module 1012 will reload the static configuration file into the static configuration data set 1014.

The configuration debugging module 1013 includes an API calling module 1015 for the configuration debugging platform 105 and a configuration reading module 1016 for the business module 1011.

The API calling module 1015 provides two API interfaces, namely, a releasing debugging configuration API and a deleting debugging configuration API, for the configuration debugging platform 105 to call. Among them. 1) the configuration debugging platform 105 can call the releasing debugging configuration API, and set the configuration debugging entry (such as entry a or entry b) in the parameters of the releasing debugging configuration API to the debugging static configuration data set 1017 in the corresponding business service node (for example, business service node 101 or 102) corresponding to the releasing debugging configuration API. The debugging static configuration data set 1017 is configuration data in the memory that only exists in the debugging stage, and is also a static configuration data set. The entry field of the debugging static configuration data set 1017 has one more effectiveness rule field than the static configuration data set 1014. This effectiveness rule field is used to determine whether the debugging configuration is effective. For example, the debugging static configuration data set 1017 includes entry a and entry b. Entry a includes key a, value a and effectiveness rule a, and entry b includes key b, value b and effectiveness rule b. 2) The configuration debugging platform 105 may call the deleting debugging configuration entry API to remove the entry corresponding to the Key from the debugging static configuration data set 1017 according to the Key. Through the cooperation of 30) the configuration debugging platform 105 and the API calling module 1015, it is convenient for operation and maintenance personnel to modify the server configuration parameters in a small range, improve the debugging efficiency, and reduce the impact range during the debugging process.

The configuration reading module 1016 can seamlessly connect the configuration data reading method of the traditional solution in a proxy manner, and the business module 1011 can read the Value of the corresponding entry according to the configured Key through the configuration reading module 1016. If there is no entry corresponding to the Key in the debugging static configuration data set 1017, the Value corresponding to the Key is directly read from the static configuration data set 1014 and returned to the business module 1011. If there is an entry corresponding to the Key in the debugging static configuration data set 1017 (that is, it means that there is a debugging configuration), it is determined whether the entry's effectiveness rules are satisfied. If the effectiveness rules are satisfied, the Value of the entry is returned to the business module 1011 for debugging configuration content. If the effectiveness rules are not satisfied, the 10) Value of the entry corresponding to the Key is read from the static configuration data set 1014 and returned to the business module 1011.

The business service node 101 also includes a dynamic configuration loading module 1018. Different from the static configuration loading module 1012, the dynamic configuration loading module 1018 connects to the configuration center service node 104, and queries and subscribes to the dynamic configuration data set 1019 from the configuration center service node 104. In addition, the dynamic configuration loading module 1018 can also accept the change push from the configuration center service node 104 and modify the dynamic configuration data set 1019 in real time. The dynamic configuration data set 1019 is different from the static configuration data set 1014. The static configuration data set 1014 is used for configurations that do not change frequently, and the dynamic configuration data set 1019 is used for configurations that change frequently. Based on the dynamic configuration loading module 1018, dynamic configuration parameter updates are realized in the entire business service node range.

Similar to the business service node 101, the business service node 102 includes a business module 1021, a static configuration loading module 1022, a configuration debugging module 1023 (including an API calling module 1025 and a configuration reading module 1026), a static configuration data set 1024, a debugging static configuration data set 1027, a dynamic configuration loading module 1028, and a dynamic configuration data set 1029. The functions of these modules of the business service node 102 are the same as the functions of the corresponding modules of the business service node 101, and are not described in detail here. It can be understood that although the business service node 101 and the business service node 102 are included in this example, the number of business service nodes can actually be arbitrary.

Based on the above server configuration debugging system, the workflow of the server configuration debugging system is described below in conjunction with FIG. 1. The server configuration debugging system includes a configuration debugging platform and one or more business service nodes, and the business service node includes a business module and a configuration debugging module. For example, the server configuration debugging system 100 in FIG. 1 includes a configuration debugging platform 105 and business service nodes 101 and 102, and the business service node 101 includes a business module 1011 and a configuration debugging module 1013: wherein,

The configuration debugging platform is used to receive a debugging configuration releasing message, the debugging configuration releasing message includes a debugging configuration entry, the debugging configuration entry includes a key, a value and effectiveness rules, for example, the configuration debugging platform 105 in FIG. 1 receives a debugging configuration releasing message input by an operation and maintenance administrator, the debugging configuration releasing message includes a debugging configuration entry a (including key a, value a and effectiveness rule a) and a debugging configuration entry b (including key b, value b and effectiveness rule b):

Furthermore, the configuration debugging platform sends the debugging configuration releasing message to the configuration debugging module of the business service node specified by the debugging configuration releasing message. For example, the configuration debugging platform 105 in FIG. 1 sends the debugging configuration entry a and the debugging configuration entry b to the configuration debugging module 1013 of the business service node 101 specified by the debugging configuration releasing message.

The configuration debugging module stores the received debugging configuration entries. For example, the configuration debugging module 1013 in FIG. 1 stores the received debugging configuration entry a and debugging configuration entry b into the debugging static configuration data set 1017; and

The configuration debugging module queries whether the debugging configuration entry contains a predetermined key according to the instruction of the business module.

In the case where the predetermined key is found, judges whether the effectiveness rule is satisfied.

In the case where the effectiveness rule is satisfied, reads the value of the debugging configuration entry and returns it to the business module: for example, in FIG. 1, when the business module 1011 needs to read the configuration data, the configuration debugging module 1013 preferentially queries whether there is an entry with a specific key in the debugging static configuration data set 1017.

If the configuration debugging module 1013 does not find the entry of the specific key (such as key a) in the debugging static configuration data set 1017, the configuration debugging module 1013 reads the entry of the specific key in the static configuration data set 1014 and returns the value of the entry to the business module 1011.

If the configuration debugging module 1013 finds the entry of the specific key in the debugging static configuration data set 1017, it determines whether the effectiveness rule of the entry of the specific key is satisfied.

If the effectiveness rule is not satisfied, the configuration debugging module 1013 reads the entry of the specific key in the static configuration data set 1014 and returns the value of the entry to the business module 1011.

If the effectiveness rule is satisfied, the configuration debugging module 1013 reads the entry of the specific key in the debugging static configuration data set 1017 and returns the value of the entry to the business module 1011. The present invention introduces the configuration center technology, and only needs to uniformly modify the configuration at the configuration center service node 104, and all business service nodes will immediately receive the configuration change notification, thereby realizing the rapid modification of configuration parameters.

The present invention can meet various configuration modification requirements of operation and maintenance administrators in the daily game operation and maintenance process, greatly improve the efficiency of operation and maintenance, and be applied to the field of game servers. It can also ensure that configuration modifications have no impact on players, improve the operability of game operations, and help game operations achieve better results.

The present invention can also perform configuration debugging and verification in a very small range. When there is a problem with the configuration parameters to be updated, the risk can be greatly reduced to avoid causing a wider range of impact. In practical applications, the operational safety of operation and maintenance can be greatly improved and operation and maintenance accidents can be reduced.

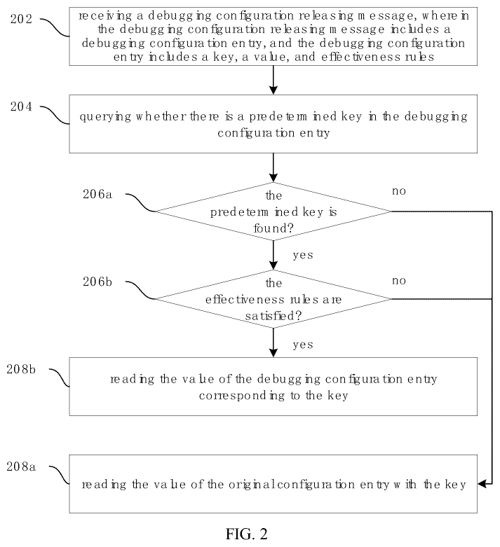

FIG. 2 is a flow chart of a server configuration debugging method according to an embodiment of the present application. An example of the server configuration debugging method is described below in conjunction with FIG. 1 and FIG. 2. The method 200 includes:

a receiving step 202, receiving a debugging configuration releasing message, wherein the debugging configuration releasing message includes a debugging configuration entry, and the debugging configuration entry includes a key, a value, and effectiveness rules: for example, the operation and maintenance administrator receives a configuration adjustment request from an operation staff or a R&D staff, the request is such as: changing the user request current limit from the original 100 to 10, that is, the entry d in the static configuration data set 1014 of the business service node 101 is:

Key=request_limits, Value=100.

Value=100 needs to be changed to Value=10. In this case, the debugging configuration releasing message input by the operation and maintenance personnel is received through the configuration debugging platform 105, that is, the operation and maintenance administrator calls the releasing debugging configuration API of the API calling module 1015 on the configuration debugging platform 105 to create a debugging configuration entry b, and entry b has the same Key as entry d, and entry b is:

Key=request_limits, Value=10, effectiveness rules:

Among them, in some embodiments of the present application, the effectiveness rules include complete effectiveness rules, probability effectiveness rules, timeliness effectiveness rules and specific effectiveness rules: wherein,
i. The complete effectiveness rule means that the debugging configuration entry will always be effective during the debugging phase. In this case, for a Key, if the entry corresponding to this Key exists in both the debugging static configuration data set 1017 and the static configuration data set 1014, the business module 1011 will only read the Value (debugging configuration) of the entry corresponding to the Key in the debugging static configuration data set 1017, but cannot read the Value (original configuration) of the entry corresponding to the Key in the static configuration data set 1014.
ii. The probability effectiveness rule allows the debugging configuration entry to be read with a predetermined probability: To further reduce the risk of configuration errors, a probability effectiveness rule, such as a probability of 0.1, can be used. In this case, for a Key, if the entry corresponding to this Key exists in both the debugging static configuration data set 1017 and the static configuration data set 1014, then the business module 1011 will read the value (debugging configuration) of the entry corresponding to this Key in the debugging static configuration data set 1017 in 10% of the cases, and will read the value (original configuration) of the entry corresponding to this Key in the static configuration data set 1014 in 90% of the cases.
iii. The timeliness rule allows the debugging configuration entry to be read within a predetermined time. That is, on the basis of the complete effectiveness and probability effectiveness rules, the timeliness rules can also be superimposed. For example, it is effective for only 1 minute, then the debugging configuration entry may take effect within one minute, and after one minute, the debugging configuration entry will not take effect, thereby further reducing the risk of configuration errors.
iv. The specific effectiveness rule allows the debugging configuration entry to be read in response to a read request carrying a predetermined ID. Under the above three rules, specific rules can also be superimposed. For example, it is effective for a specific user ID, then the debugging configuration entry is used only for requests from this user during business processing, and will not be used for other users' requests. This rule is often used by Quality Assurance (QA) personnel to test specific user IDs (such as test-specific IDs) to avoid affecting normal users. The risk probability of configuration errors can be reduced to almost 0.

Querying step 204, querying whether there is a predetermined key in the debugging configuration entry: for example, when the business module 1011 (game server program) needs to read the configuration of user request current limit, the configuration reading module 1016 preferentially queries whether there is an entry with Key=request_limits in the debugging static configuration data set 1017.

Judging step 206a, judging whether the predetermined key is found: that is, judging whether there is an entry with Key=request_limits among all the entries in the debugging static configuration data set 1017.

If the predetermined key cannot be found, reading the value of the original configuration entry with the key in the reading step 208a: for example, if the above-mentioned entry b is not added to the debugging static configuration data set 1017, the configuration reading module 1016 does not find the entry with Key=request_limits in the debugging static configuration data set 1017, then the configuration reading module 1016 reads the entry with Key=request_limits (entry d) in the static configuration data set 1014.

If the predetermined key is found, then in judging step 206b, judging whether the effectiveness rule is satisfied: for example, when the above-mentioned entry b is added to the debugging static configuration data set 1017, the configuration reading module 1016 finds the entry (entry b) with Key=request_limits in the debugging static configuration data set 1017, then judging whether the effectiveness rules of entry b are satisfied.

If the effectiveness rule is not satisfied, reading the value of the original configuration entry with the key in the reading step 208a: for example, the configuration reading module 1016 reads the entry with Key=request_limits in the static configuration data set 1014 (entry d).

If the effectiveness rule is satisfied, reading the value of the debugging configuration entry corresponding to the key in the reading step 208b. For example, the configuration reading module 1016 reads the entry with Key=request_limits in the debugging static configuration data set 1017 (entry b).

The embodiments of the present application can also perform configuration debugging and verification in a very small range. When there is a problem with the configuration parameters to be updated, the risk can be greatly reduced to avoid causing a wider range of impact. In practical applications, the operational safety of operation and maintenance can be greatly improved and operation and maintenance accidents can be reduced.

Similarly, the operation and maintenance administrator can also selectively add entry b to the debugging static configuration data set of business service node 102 or more other business service nodes in thesame way, and set corresponding effectiveness rules, so that business service node 102 or more other business service nodes implement functions similar to those of business service node 101. On the basis of satisfying the configuration verification, the impact range of debugging can be further reduced. The problem of the great risk generated once the configuration is updated incorrectly is solved, and the risk is locked within a controllable range.

According to some embodiments of the present application, the server configuration debugging method further includes:

Receiving a debugging configuration deletion message, wherein the debugging configuration deletion message includes a debugging configuration deletion field: for example, after releasing the above debugging configuration entry (entry b), the Quality Assurance personnel will go online to perform configuration testing. If any configuration problem is found, the operation and maintenance administrator will be notified to quickly operate the configuration debugging platform 105 to delete the debugging configuration entry (entry b) and quickly roll back. Specifically, the operation and maintenance administrator calls the deleting debugging configuration API of the API calling module 1015 of the business service node 101 on the configuration debugging platform 105 to input the configuration deletion message, and the configuration deletion message includes the deletion field request_limits.

Deleting the debugging configuration entry whose key is the debugging configuration deletion field. For example, the API calling module 1015 deletes the entry whose Key is request_limits in the debugging static configuration data set 1017, that is, entry b. In this way, for the business service node 101, entry b (debugging configuration) will not be read later, and a quick rollback is achieved.

In this application, once a problem is found in the configuration content, the configuration of these nodes can be quickly rolled back without reloading the configuration file or re-pulling it from the configuration center. Rapid emergency handling after the risk occurs further reduces the impact of configuration update problems.

After releasing the above debugging configuration entry (entry b), after being tested by the Quality Assurance (QA) personnel, if the debugging test passes, the operation and maintenance administrator modifies the configuration file in the object storage service node 103, or modifies the dynamic configuration data set in the configuration center service node 104 to apply the value of the debugging configuration entry (entry b). Then let each business service node reload the corresponding configuration entry to make the configuration permanent. It can be seamlessly combined with traditional configuration management solutions, which can help developers quickly access existing systems.

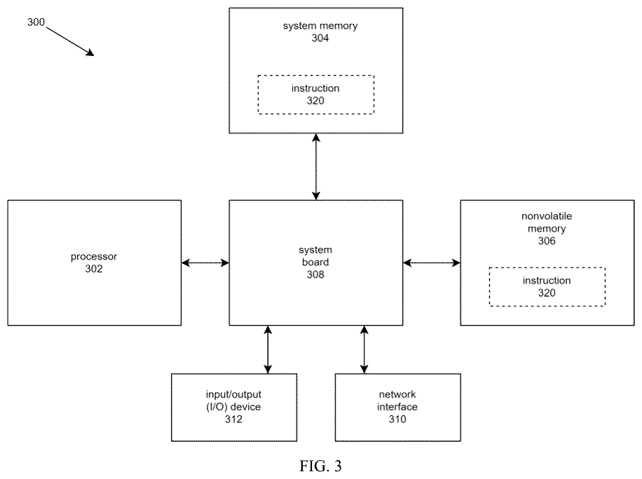

FIG. 3 is a hardware structure block diagram of a computer device for implementing server configuration debugging according to an embodiment of the present invention.

As shown in FIG. 3, a computer device 300 may include one or more processors 302, a system board 308 connected to at least one of the processors 302, a system memory 304 connected to the system board 308, a nonvolatile memory (NVM) 306 connected to the system board 308, and a network interface 310 connected to the system board 308.

The processor 302 may include one or more single-core or multi-core processors. The processor 302 may include any combination of a general-purpose processor and a special-purpose processor (such as, a graphics processing unit, an application processor, or a baseband processor). In an embodiment of this invention, the processor 302 may be configured to perform one or more embodiments according to various embodiments shown in FIG. 2.

In some embodiments, the system board 308 may include any suitable interface controller, to provide any suitable interface for at least one of the processors 302 and/or any suitable device or component communicating with the system board 308.

In some embodiments, the system board 308 may include one or more memory controllers to provide an interface connected to the system memory 304. The system memory 304 may be used to load and store data and/or an instruction. In some embodiments, the system memory 304 of the electronic device 300 may include any suitable volatile memory, such as a suitable dynamic random access memory (DRAM).

NVM 306 may include one or more tangible and non-transitory computer-readable media for storing data and/or the instruction. In some embodiments, NVM 306 may include any suitable nonvolatile memory such as a flash memory and/or any suitable nonvolatile storage device, such as a HDD (Hard Disk Drive, hard disk drive), a CD (Compact Disc, Compact Disc) drive, a DVD (Digital Versatile Disc, Digital Versatile Disc) drive.

NVM 306 may include a portion of storage resources installed on the apparatus of the electronic device 300, or may be accessed by a device, but is not necessarily part of a device. For example, NVM 306 may be accessed over a network via the network interface 310.

In particular, the system memory 304 and the NVM 306 may respectively include: a temporary copy and a permanent copy of the instruction 320. The instruction 320 may include: an instruction that causes the electronic device 300 to implement the method shown in FIG. 2 when executed by at least one of the processors 302. In some embodiments, the instruction 320, hardware, firmware, and/or software components thereof may additionally/alternatively reside in the system board 308, the network interface 310, and/or the processor 302.

The network interface 310 may include a transceiver for providing a radio interface for the electronic device 300 to communicate with any other suitable devices (such as, a front-end module and an antenna) by using one or more networks. In some embodiments, the network interface 310 may be integrated with other components of the electronic device 300. For example, the network interface 310 may be integrated into at least one of the processor 302, the system memory 304, the NVM 306, and a firmware device (not shown) having an instruction, and when at least one of the processors 302 executes the instruction, the electronic device 300 implements one or more of the various embodiments shown in FIG. 2.

The network interface 310 may further include any suitable hardware and/or firmware to provide a multiple-input multiple-output wireless interface. For example, the network interface 310 may be a network adapter, a wireless network adapter, a telephone modem, and/or a wireless modem.

In one embodiment, at least one of the processors 302 may be packaged with one or more controllers used for the system board 308 to form a system in a package (SiP). In one embodiment, at least one of the processors 302 may be integrated on the same die with one or more controllers used for the system board 308 to form a system on a chip (SoC).

The computer device 300 may further include: an input/output (I/O) device 312 connected to the system board 308. The I/O device 312 may include a user interface, so that a user can interact with the electronic device 300: peripheral components can also interact with the electronic device 300 by using a design of a peripheral component interface. In some embodiments, the electronic device 300 further includes a sensor for determining at least one of environmental conditions and location information related to the electronic device 300.

In some embodiments, the I/O device 312 may include, but is not limited to, a display (such as, a liquid crystal display and a touch screen display), a speaker, a microphone, one or more cameras (such as, a still image camera and/or a video camera), a flashlight (such as, a LED flash), and a key board.

In some embodiments, the peripheral component interface may include, but is not limited to, a nonvolatile memory port, an audio jack, and a power interface.

In some embodiments, sensors may include, but are not limited to, gyroscope sensors, accelerometers, proximity sensors, ambient light sensors, and positioning units. The positioning unit may also be part of or interact with the network interface 310 to communicate with components of the positioning network, such as Global Positioning System (GPS) satellites.

It can be understood that the structure illustrated in the embodiment of the present invention does not constitute a specific limitation on the computer device 300. In other embodiments of the present application, the computer device 300 may include more or fewer components than those shown in the figure, or combine some components, or split some components, or have different component arrangements. The illustrated components may be implemented in hardware, software, or a combination of software and hardware.

Program code can be applied to input instructions to perform the functions described in the present invention and to generate output information. The output information may be applied to one or more output devices in a known manner. For purposes of the present application, a system used for processing the instructions and including the processor 302 includes any system with a processor such as a digital signal processor (DSP), a microcontroller, an application specific integrated circuit (ASIC), or a microprocessor.

The program code can be implemented in a high-level programming language or an object-oriented programming language to communicate with a processing system. The program code can also be implemented in an assembly language or a machine language, if desired. In fact, the mechanism described in the present invention is not limited in scope to any particular programming language. In either case, the language may be an assembly language or an interpreted language.

One or more aspects of at least one embodiment may be implemented by instructions stored on a computer-readable storage medium that, when read and executed by a processor, enable an electronic device to implement the methods of the embodiments described in this invention.

According to some embodiments of the present application, disclose a computer storage medium having stored thereon instructions which, when run on a computer, cause the computer to perform any of the possible methods of the first embodiment described above.

The first embodiment is a method embodiment corresponding to the present embodiment, which can be implemented in cooperation with the first embodiment. The relevant technical details mentioned in the first embodiment are still valid in the present embodiment, and in order to reduce repetition, details are not described herein. Accordingly, the relevant technical details mentioned in the present embodiment may also be applied to the first embodiment.

According to some embodiments of the present application, a computer program product is disclosed, including computer-executable instructions executed by a processor to implement the server configuration debugging method according to the embodiment of this invention.

The first embodiment is a method embodiment corresponding to the present embodiment, which can be implemented in cooperation with the first embodiment. The relevant technical details mentioned in the first embodiment are still valid in the present embodiment, and in order to reduce repetition, details are not described herein. Accordingly, the relevant technical details mentioned in the present embodiment may also be applied to the first embodiment.

In some cases, the disclosed embodiments may be implemented in hardware, firmware, software, or any combination thereof. The disclosed embodiments may also be implemented in the form of instructions or programs carried or stored on one or more transient or non-transient machine-readable (e.g., computer-readable) storage media, which may be read and executed by one or more processors or the like. When instructions or programs are run by a machine, the machine may perform the various methods described above. For example, the instructions may be distributed over a network or other computer-readable medium. Thus, a machine-readable medium may include, but is not limited to, any mechanism for storing or transmitting information in a form readable by a machine (e.g., a computer), such as a floppy disk, an optical disk, an optical disk read-only memory (CD-ROMs), a magneto-optical disk, a read-only memory (ROM), a random access memory (RAM), an erasable programmable read-only memory (EPROM), an electronically erasable programmable read-only memory (EEPROM), a magnetic or optical card, or a flash or tangible machine-readable memory for transmitting network information through electrical, optical, acoustic, or other forms of signals (e.g., a carrier wave, an infrared signal, a digital signal, etc.). Thus, a machine-readable medium includes any form of machine-readable medium suitable for storing or transmitting electronic instructions or machine (e.g., computer) readable information.

The embodiments of the present application have been described in detail above in connection with the drawings, but the use of the technical solutions of the present application is not limited to the various applications mentioned in the examples of the present patent, and various structures and variations can be readily implemented with reference to the technical solutions of the present application to achieve the various advantages mentioned herein. Various changes made without departing from the purpose of the present application shall fall within the scope of the patent of the present application, within the knowledge of one of ordinary skill in the art.

1. A server configuration debugging method, the method includes:
a receiving step, receiving a debugging configuration releasing message, wherein the debugging configuration releasing message includes a debugging configuration entry, and the debugging configuration entry includes a key, a value, and effectiveness rules;
a querying step, querying whether the debugging configuration entry contains a predetermined key;
a judging step, in the case where the predetermined key is found, judging whether the effectiveness rule is satisfied;
a reading step, in the case where the effectiveness rule is satisfied, reading the value.

2. The method of claim 1, the effectiveness rules include probability effectiveness rules, timeliness effectiveness rules and specific effectiveness rules; wherein,
the probability effectiveness rule allows the debugging configuration entry to be read with a predetermined probability;
the timeliness effectiveness rule allows the debugging configuration entry to be read within a predetermined time;
the specific effectiveness rule allows the debugging configuration entry to be read in response to a read request carrying a predetermined ID.

3. The method of claim 1, further including:
receiving a debugging configuration deletion message, wherein the debugging configuration deletion message includes a debugging configuration deletion field;
deleting the debugging configuration entry whose key is the debugging configuration deletion field.

4. The method of claim 1, further including:
when the predetermined key cannot be found or the effectiveness rule is not satisfied, reading the value of the original configuration entry with the key.

5. The method of claim 1, the receiving step further includes:
storing the debugging configuration entry.

6. A server configuration debugging system including a configuration debugging platform and one or more business service nodes, wherein the business service nodes include a business module and a configuration debugging module, wherein:
the configuration debugging platform receives a debugging configuration releasing message, wherein the debugging configuration releasing message includes a debugging configuration entry, and the debugging configuration entry includes a key, a value, and effectiveness rules;
and the configuration debugging platform sends the debugging configuration releasing message to the configuration debugging module of the business service node specified by the debugging configuration releasing message;
the configuration debugging module stores the received debugging configuration entry, and according to the instruction of the business module, queries whether the debugging configuration entry contains a predetermined key,
in the case where the predetermined key is found, judges whether the effectiveness rule is satisfied,
in the case where the effectiveness rule is satisfied, reads the value and returns it to the business module.

7. The system of claim 6, the effectiveness rules include probability effectiveness rules, timeliness effectiveness rules and specific effectiveness rules; wherein,
the probability effectiveness rule allows the debugging configuration entry to be read with a predetermined probability;
the timeliness effectiveness rule allows the debugging configuration entry to be read within a predetermined time;
the specific effectiveness rule allows the debugging configuration entry to be read in response to a read request carrying a predetermined ID.

8. The system according to claim 6, wherein,
the configuration debugging platform also receives a debugging configuration deletion message, wherein the debugging configuration deletion message includes a debugging configuration deletion field; and the configuration debugging platform sends the debugging configuration deletion message to the configuration debugging module of the business service node specified by the debugging configuration deletion message;
after receiving the debugging configuration deletion message, the configuration debugging module deletes the debugging configuration entry whose key is the debugging configuration deletion field.

9. The system according to claim 6, wherein, the configuration debugging module reads the value of the original configuration entry with the key, when the predetermined key cannot be found or the effectiveness rule is not satisfied.

10. A computer device, the device including a processor and a memory storing computer-executable instructions which, when executed by the processor, cause the device to implement the server configuration debugging method according to claim 1.

11. A computer storage medium having stored thereon instructions which, when run on a computer, cause the computer to perform the server configuration debugging method according to claim 1.

12. A computer program product including computer-executable instructions executed by a processor to implement the server configuration debugging method according to claim 1.
